(19) United States
(12) Patent Application Publication
(10) Pub. No.: US 2007/0139192 A1
(43) Pub. Date: Jun. 21, 2007

(54) Sensor unit having a network video camera

(76) Inventors: Michael R. Wimberly, Sammamish, WA (US); Jeffrey D. Ollis, Dresher, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/313,398

(22) Filed: Dec. 21, 2005

(51) Int. Cl. G08B 1/08; H04N 7/18

(52) U.S. Cl. 340/539.22; 348/143

(57) ABSTRACT

A sensor unit includes a network video camera and a sensor operable to detect a condition of an environment. A power connector connects the sensor unit to a power line, and a signal connector connects the sensor to a signal line. The sensor is operable to output a signal on the signal line via the signal connector indicating whether the condition of the environment was detected. A network interface is operable to transmit video captured by the network video camera to a remote location via a network. A controller is operable to receive a signal from the sensor indicating whether the condition of the environment was detected. The controller is further operable to control transmission of video captured by the network video camera to a remote location via the network interface based on one or more of access rights of a user and whether the condition of the environment was detected.

### BACKGROUND

Homes and other buildings typically use security systems with motion detectors and other sensors for detecting intruders. Many of these security systems are connected to monitoring companies that respond to intruder detection performed by the security systems.

These security systems are highly susceptible to generating false alarms. For example, pets or improper use of an alarm system by a home owner or other authorized user can generate false alarms. Time and resources may be wasted due to false alarms. For example, a typical scenario includes a monitoring company detecting an alarm at a home. The monitoring company notifies the police, and the police are dispatched to the site of the alarm. The police arrive at the scene and find that nothing is wrong. The police may fine the home owner for repeated false alarms.

As a result of the large number of false alarms, many monitoring companies are requiring video verification of an intruder in order for the monitoring company to take action, such as notifying the police. However, many existing security systems, especially home security systems, do not include video cameras. Furthermore, retrofitting an existing security system with cameras can be expensive and complicated. For example, video cameras must be mounted in locations where they can have an optimal view of the zone being monitored, which is typically at least seven feet from the ground in a corner of the zone. Also, power cables must be run to the video cameras. This may result in unsightly, exposed, power cables in a home.

### SUMMARY

According to an embodiment, a sensor unit includes a network video camera and a sensor operable to detect a condition of an environment. A power connector connects the sensor unit to a power line, and a signal connector connects the sensor to a signal line. The sensor is operable to output a signal on the signal line via the signal connector indicating whether the condition of the environment was detected. A network interface is operable to transmit video captured by the network video camera to a remote location via a network. A controller is operable to receive a signal from the sensor indicating whether the condition of the environment was detected. The controller is further operable to control transmission of video captured by the network video camera to a remote location via the network interface based on one or more of access rights of a user and whether the condition of the environment was detected.

### BRIEF DESCRIPTION OF THE DRAWINGS

Embodiments are illustrated by way of example and not limited in the following figure(s), in which like numerals indicate like elements, in which:

FIG. 1 illustrates a system, according to an embodiment;

FIG. 2 illustrates a sensor unit, according to an embodiment;

FIG. 3 illustrates software in a sensor unit, according to an embodiment;

FIGS. 4A-B illustrate replacing a sensor with a sensor unit, according to an embodiment; and

FIG. 5 illustrates a flowchart of a method for replacing a sensor with a sensor unit, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

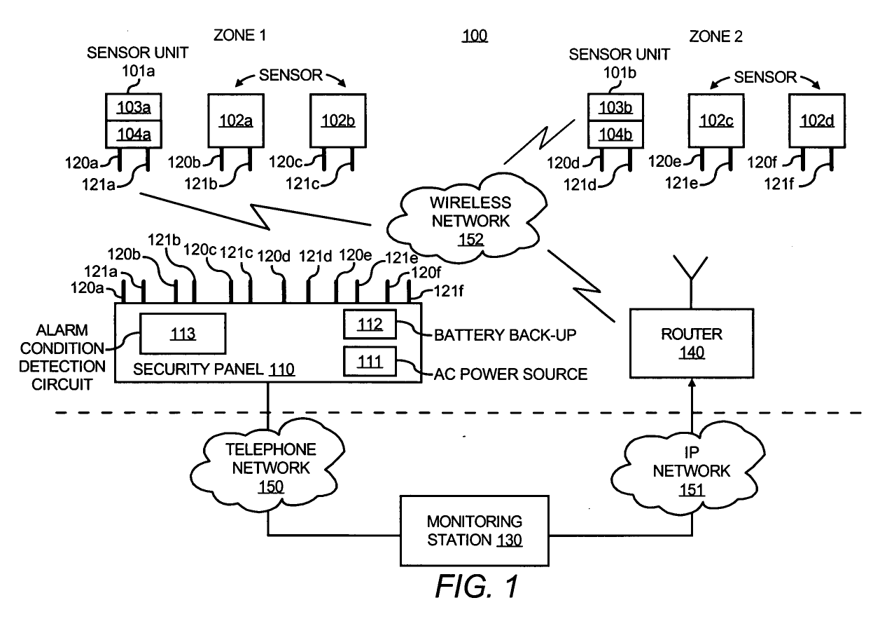

FIG. 1 illustrates a security system 100, according to an embodiment. The security system 100 includes zones 1-2 with sensor units 101a-b and sensors 102a-d for monitoring the zones 1 and 2. The sensors 102a-d detect environmental conditions. Examples of the sensors 102a-d include motion detectors, glass break sensors, heat sensors, smoke detectors, carbon monoxide detectors. The detected environmental conditions may include detection of motion, detection of breaking glass, detection of heat representative of body heat, detection of smoke, or detection of carbon monoxide performed by the sensors 102a-d. The sensors 102a-d may include other types of sensors commonly used in security systems or otherwise known in the art. The sensors 102a-d may be used to detect unauthorized individuals or hazardous conditions, such as fire or carbon monoxide, in the zones 1-2. The zones 1-2 may include predetermined areas to be monitored. These areas may be indoor areas, outdoor areas, or a combination of indoor and outdoor area. The zones may be in a premises, such as in a home, other buildings, sections of a building, or in outdoor areas.

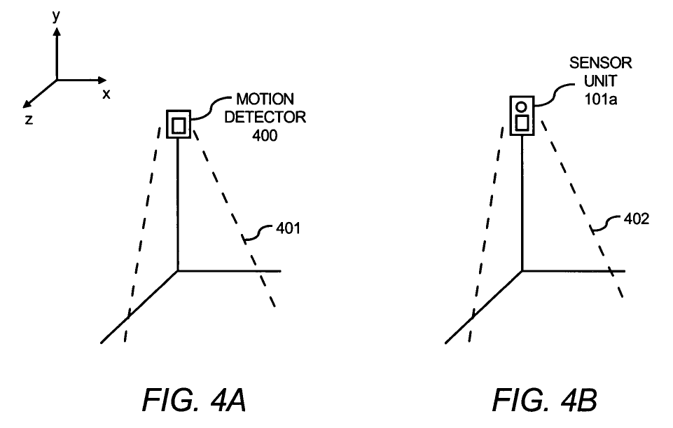

The sensor units 101a-b include network video cameras 103a-b and sensors 104a-b. A sensor unit is a single unit that includes a network video camera and a sensor. According to an embodiment, the sensor units 101a-b each replace a previously installed sensor, and thus the sensor units 101a-b are operable to use the power connections and signal connections of the sensors being replaced. This is described in further detail with respect to FIGS. 4A-B.

The sensors 104a-b in the sensor units 101a-b also detect environmental conditions and may include motion detectors, glass break sensors, heat sensors, smoke detectors, carbon monoxide detectors or other known sensors. The network video cameras 103a-b capture video of the respective zones 1-2. The video may be used to determine whether an unauthorized person has entered one of the zones 1 and 2. An alarm condition may be triggered by one or more of the sensors 102a-d and 104a-b. For example, the sensor 104a detects motion in zone 1 or the sensor 102a detects breaking glass in zone 1. Video may be used to verify that an authorized person has entered a zone or verify that a hazardous condition has occurred in a zone. For example, video captured by the network video camera 103a is used to verify that an unauthorized individual has entered zone 1 in response to the alarm condition triggered by sensor 104a or sensor 102a.

The system 100 may include a security panel 110 powered by an AC power source 111 and a battery back-up 112. The sensors 102a-d and the sensor units 101a-b are connected to the security panel 110 via power lines 120a-f and sensor lines 121a-f. Although not shown as connected, the lines 120a-f and sensor lines 121a-f are power and signal lines connecting the security panel 110 to the sensors 102a-d and the sensor units 101a-b. The power lines 120a-f supply power to the sensors 102a-d and the sensor units 101a-b from the AC power source 111 or the battery back-up 112 if the AC power source 111 failed, for example, due to a power outage or another reason.

For example, the security panel 110 is powered through the AC power source 111, which may include a 24 VAC transformer that gets its power from a 120 VAC common outlet. The security panel 110 converts the 24 VAC power to 12 VDC and sends that power to all powered sensors in the system 100. For example, the security panel 110 sends power to the sensors 102a-d and the sensor units 101a-b via the power lines 120a-f. As a backup, the security panel is also connected to the battery back-up 112, such as a 12 VDC battery backup system, in the event the 120 VAC is no longer available and therefore the 24 VAC is no longer available. The security system can be powered by the 12 VDC battery backup along with all the sensors receiving power from the security panel 110. Thus, the zones 1 and 2 can still be secured in the event of a power outage. The sensor units 101a-b as well as the sensors 102a-d may be powered by the same 12 VDC battery backup, and therefore also be available during a power outage.

Each of the power lines 120a-f may include a two-wire power line carrying low voltage for supplying power to sensors and sensor units. Each of the signal lines 121a-f may include a two-wire signal line carrying signals indicative of a detected environmental condition. Motion detectors and other sensors commonly use a two-wire signal line. Other power lines and signal lines may be used as are known in the art.

The sensors 102a-d and the sensor units 101a-b are operable to output a signal on the signal lines 121a-f in response to detecting an environmental condition. In one embodiment, the signal comprises a voltage. For example, a first voltage, such as 0-1 volts, on a signal line indicates that no environmental condition is detected and a second voltage, such as 4.5-5.5 volts, on a signal line indicates that an environmental condition is detected. An alarm condition detection circuit 113 at the security panel 110 is operable to detect a signal from one or more of the sensors 102a-d and the sensor units 101a-b on corresponding signal lines 121a-f indicative of a detected environmental condition. An alarm condition is triggered in response to detecting the environmental condition. A signal or message indicative of the triggered alarm condition may be transmitted to a remote location, such as a monitoring station 130, from the security panel 110, for example, via a telephone network 150.

The network video cameras 103a-b are operable to transmit video to a remote location, such as the monitoring station 130, via a network. The network video cameras 103a-b may transmit video via one or more IP networks. For example, the network video cameras 103a-b may transmit video to the router 140 via a wireless connection in a local area network 152. The network video cameras 103a-b can be connected to the router 140 via a wired connection instead of a wireless connection. In one embodiment, only the network video cameras 103a-b, and not the sensors 104a-b, transmit video via the network 152. In other embodiments, the sensor 104a-b and possibly other sensors in the system 100 also transmit data via the network 152 instead of via the wired lines 121 connecting the sensors to the security panel 110. The router 140 transmits the video received from the network video cameras 103a-b via the network 152 to the monitoring station 130 via the network 151. The network 151 may include the Internet and/or other private or public networks. The dashed line shown in FIG. 1 represents a logical division between an area being monitored and a remote location, such as the monitoring station 130.

For example, the monitoring station 130 receives a message from the security panel 110 via the telephone network 150 indicative of an alarm condition triggered by an environmental condition detected by the sensor 104a in zone 1. A user at the monitoring station logs into the network video camera 103a via the networks 151 and 152. The user requests the network video camera 103a to transmit video of zone 1 to the monitoring station 130. The video from the network video camera 103a is received at the monitoring station 130, and is used to determine whether the alarm condition is a false alarm or a true alarm condition. For example, if an unauthorized person is present in the video, then the alarm condition is a true alarm condition and the police may be dispatched to the location of the alarm. If a pet is seen in the video, then the police may not be dispatched.

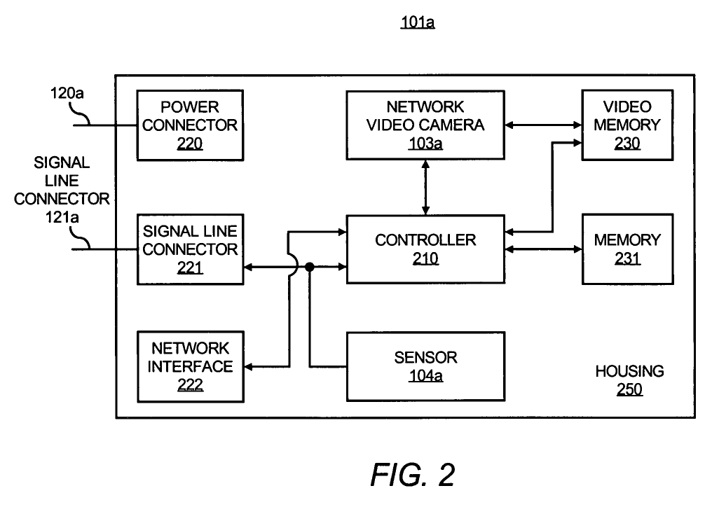

As described in further detail with respect to FIG. 2, access rights can be set at the network video cameras 103a-b to prevent unauthorized access to video captured by the network video cameras 103a-b. Examples of access rights include user IDs and passwords and under what conditions the users are allowed to receive video. For example, one condition may include whether a user is allowed to receive video only in an alarm condition. Monitoring station personnel may have rights to receive video only in an alarm condition. A system administrator or a family member, if the system 100 is in a home, may have access rights to receive video at any time, regardless of whether an alarm condition is triggered. An alarm condition may be triggered in response to one or more of the sensors 102a-d and 104a-b sensing an environmental condition.

The network video cameras 103a-b may be triggered to capture video in response to an alarm condition. For example, the sensor 104a in the sensor unit 101a detects an environmental condition, and the network video camera 103a is triggered to capture video of zone 1. For example, the network video camera 103a is changed from an off state to an on state to capture video. In another example, the alarm condition may be triggered by another sensor unit. For example, the sensor 104b in the sensor unit 101b triggers an alarm condition. The network video camera 103b is then triggered to capture video of zone 2. Also, the sensor unit 101b transmits a signal to the sensor unit 101a via the network 152 indicating that the alarm condition has been triggered. The sensor unit 101a then triggers the video camera 103a to capture video of zone 1. Thus, if one network video camera is triggered to capture video, then other video cameras in the area may also be triggered to capture video. Then, if an unauthorized individual is captured by video for zone 2 and moves quickly to zone 1, the unauthorized individual may also be captured by video for zone 1 because the alarm condition is already triggered for the sensor unit 101a in zone 1. The triggering of a network video camera is further described in U.S. patent application Ser. No. (TBD) (Attorney Docket Number BCS03903), by Kister et al., filed on Dec. 13, 2005, which is incorporated by reference in its entirety.

In another embodiment, the network video cameras 103a-b continuously capture video and remote access to the video captured by the network video cameras 103a-b is controlled by the access rights. More power may be consumed in this embodiment because the network video cameras 103a-b continuously capture video instead of being triggered to capture video in an alarm condition. Also, the network video cameras 103a-b may include multiple modes of operation. For example, in one mode of operation the network video cameras 103a-b continuously capture video, and in another mode of operation the network video cameras 103a-b are triggered to capture video in an alarm condition.

It will be apparent to one of ordinary skill in the art that the number of sensors and sensor units in the system 100 may vary as needed to provide adequate monitoring of a premise. Also, a premise may include one or more zones and may be indoor or outdoor. A zone may include a predetermined area in a premise.

FIG. 2 illustrates a block diagram of the sensor unit 1011a, according to an embodiment. The components of the sensor unit 101a may be used for any of the sensor units in the system 100.

The sensor unit 101a includes a controller 210, the network video camera 103a, the sensor 104a, video memory 230, memory 231, power connector 220, signal line connector 221 and network interface 222. The network video camera 103a captures video, and the captured video may be stored in the video memory 230. A network video camera may include a CCD camera or CMOS camera and a network interface for transmitting video via a network as is known in the art. The embodiment shown in FIG. 2 illustrates a separate network interface 222. The network interface 222 may be included in the network video camera 103a for transmitting video and transmitting and receiving other signals via the network 152.

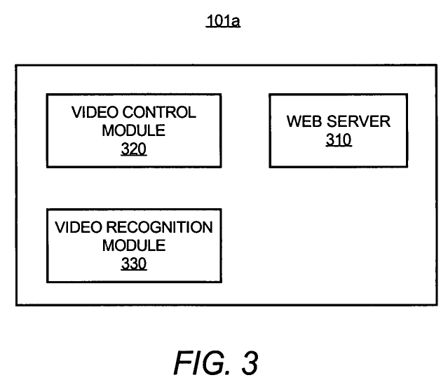

The memory 231 stores user IDs, passwords, and other access rights for users. The memory 231 may also store software for the sensor unit as is further described with respect to FIG. 3.

The sensor 104a is operable to detect an environmental condition. If the environmental condition is detected, a signal is sent to the signal line connector 221 and the controller 210. The signal line connector 221 is connected to the signal line 121a and is an interface for transmitting a signal indicative of the detected environmental condition to the security panel 110. Also, the sensor unit 101a and its components receive power from the power line 120 via the power connector 220. Power may be distributed to the components of the sensor unit 101a via a power but, not shown.

The controller 210 performs several functions for the sensor unit 101a. The controller 210 is operable to detect an alarm condition and trigger the network video camera 103a to capture video. Detecting an alarm condition may include receiving a signal from the sensor 104a indicating that an environmental condition is detected. The controller 210 may also detect an alarm condition by receiving a signal from another sensor unit via the network interface 222 indicating that an environmental condition is detected by another sensor.

The controller 210 is also operable to control remote access to video captured by the network video camera 103a. The controller 210 controls transmission of video via the network interface 222 to a remote location, such as the monitoring station 130 shown in FIG. 1, through access rights stored in the memory 231. The network interface 222 may be connected to the router 140 shown in FIG. 1 or another network device via the network 152 for transmitting video to the monitoring station 130 or another remote location via the network 151.

The controller 210 may also be operable to perform video recognition to determine whether an image in the captured video includes features of authorized individuals. Based on the image processing, the controller 210 may transmit a signal via the network interface 22 to the monitoring station 130 indicating whether the image represents an authorized individual or not.

The sensor unit 101a may be provided as a single unit including the network video camera 103a, the sensor 104a and other components. The sensor unit 101a may be provided in a single housing 250.

It will be apparent to one of ordinary skill in the art that the components shown in FIG. 2 are examples of components that may be used in the sensor unit 101a. The sensor unit 101a may include other components as is known in the art for performing the functions described above. Also, one or more of the components may optionally be used in the sensor unit 101a.

FIG. 3 illustrates software that may be stored and executed by the sensor unit 101a, according to an embodiment. The software may be used by any sensor unit in the system 100. The software includes a web server 310, a video control module 320 and a video recognition module 330. The web server 310 controls remote access to the network video camera 103a shown in FIG. 2, which may include controlling transmission of video captured by the network video camera 103a using access rights stored in the memory 231 shown in FIG. 2. For example, the web server 310 receives a user ID and password from a user at the monitoring station 130 shown in FIG. 1. The web server 310 compares the user ID and password to user IDs and passwords stored in the memory 231 shown in FIG. 2 to determine whether a stored user ID and password matches the received user ID and password. If a match is found, the web server 310 determines whether there are any conditions specified in the access rights for the user ID for accessing video captured by the network video camera 103a. Conditions may include that the user can only access video during an alarm condition. If there is an alarm condition, the controller transmits video to the monitoring station 130. Other user access rights may be set at the web server 310.

The video control module 320 determines whether to trigger the network video camera 103a, for example, in response to detecting an alarm condition. The video recognition module 330 may include known image recognition software for determining whether an image in the captured video includes features of authorized individuals.

It will be apparent to one of ordinary skill in the art that the software components shown in FIG. 3 are examples of software components that may be used in the sensor unit 101a. The sensor unit 101a may include other software components as is known in the art for performing the functions described above. Also, one or more of the software components may optionally be used in the sensor unit 101a.

FIGS. 4A-B illustrate replacing an existing sensor with the sensor unit 101a. The motion detector 400 shown in FIG. 4A may be included in an existing security system with limited or no video capability. According to an embodiment, the sensor unit 101a replaces a sensor, such as the motion detector 400 shown in FIG. 4A. Thus, the sensor unit 101a is operable to use the power connections and signal connections of the replaced motion detector 400 and is operable to provide video of the coverage area. FIG. 4A shows the motion detector 400 and coverage area 401 where the motion detector can detect motion prior to the motion detector 400 being replaced.

The location of the motion detector 400 is also optimal for a video camera. For example, the motion detector is located in a corner that may be 6-10 feet from the ground. Because of the optimal location, the motion detector 400 may be selected for replacement with the sensor unit 101a. FIG. 4B shows the sensor unit 101a replacing the motion detector 400 and the coverage area for the sensor unit 101a. The sensor unit 101a may be provided in the same location as the motion detector 400 and the sensor unit may use the power line and signal line of the motion detector 400. Thus, new power lines and signal lines do not need to be provided for the sensor unit 101a. In addition, the sensor unit 101a is operable to provide video of the zone 1, which may not have been available previously.

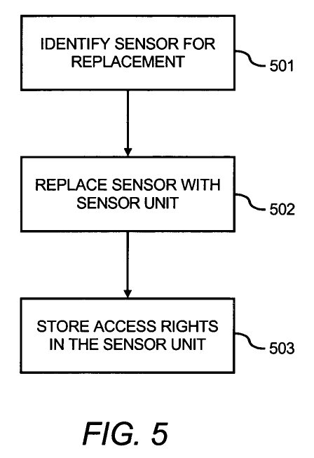

FIG. 5 illustrates a flowchart of a method 500 for replacing a sensor with a sensor unit, according to an embodiment. The method 500 is described with respect to FIGS. 1-4 by way of example and not limitation, and the method 500 may be used with other systems and components.

At step 501, an existing sensor is identified for replacement. For example, the motion detector 400 shown in FIG. 4A is selected for replacement because of its optimal location for video surveillance.

At step 502, the existing sensor is replaced with a sensor unit. For example, the motion detector 400 shown in FIG. 4A is replaced with the with the sensor unit 101a shown in FIG. 4B. The sensor unit 101a may use the power line 120a and signal line 121a shown in FIG. 2 which were previously connected to the motion detector 400.

At step 503, access rights are stored in the sensor unit 101a. The access rights may include user IDs and passwords and conditions for each user ID. The conditions may specify whether users can receive video from the sensor unit 101a only in an alarm condition.

After becoming operational, the sensor unit 101a is operable to trigger the network video camera 103a in response to detecting an alarm condition. Also, the sensor unit 101a is operable to control remote access to the video captured by the network video camera 103a using the access rights.

One or more of the steps of the method and other steps described herein and software described herein may be implemented as software embedded or stored on a computer readable medium, such as the memory 231 shown in FIG. 2 or other storage. The steps may be embodied by a computer program, which may exist in a variety of forms both active and inactive. For example, they may exist as software program(s) comprised of program instructions in source code, object code, executable code or other formats for performing some of the steps when executed. Modules include software, such as programs, subroutines, objects, etc. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A sensor unit comprising:
a network video camera;
a sensor operable to detect a condition of an environment;
a power connector connecting the sensor unit to a power line;
a signal connector connecting the sensor to a signal line, wherein the sensor is operable to output a signal on the signal line via the signal connector indicating whether the condition of the environment was detected;
a network interface operable to transmit video captured by the network video camera to a remote location via a network;
a memory storing access rights; and
a controller operable to receive a signal from the sensor indicating whether the condition of the environment was detected and the controller is further operable to control transmission of video captured by the network video camera to a remote location via the network interface based on one or more of access rights of a user stored in the memory and whether the condition of the environment was detected.

2. The sensor unit of claim 1, wherein the access rights indicate whether the user is authorized to receive the video.

3. The sensor unit of claim 2, wherein the access rights indicate whether the user has rights to receive the video only in an alarm condition.

4. The sensor unit of claim 3, wherein the alarm condition is triggered in response to the sensor detecting the condition of the environment.

5. The sensor unit of claim 3, wherein the alarm condition is triggered in response to receiving a signal from another sensor unit, the signal indicating that a sensor in the another sensor unit has detected a condition of the environment.

6. The sensor unit of claim 1, wherein the network video camera is triggered to capture video in response to an alarm condition.

7. The sensor unit of claim 6, wherein the alarm condition is triggered in response to the sensor detecting the condition of the environment.

8. The sensor unit of claim 1, further comprising a video recognition module operable to determine whether a captured image includes features of a predetermined individual.

9. The sensor unit of claim 1, wherein the power line comprises a two-wire power line wired to a security panel including an AC power supply and battery back-up.

10. The sensor unit of claim 9, wherein the signal line comprises a two-wire line connected to the security panel.

11. The sensor unit of claim 10, wherein the sensor unit replaces a sensor previously installed at a location of the sensor unit, such that the sensor unit is operable to use the power line and the signal line of the replaced sensor at the location.

12. The sensor unit of claim 10, wherein the location is optimal for video surveillance of a zone.

13. An apparatus comprising:
video camera means for generating video of a surveillance area;
sensor means for detecting a condition of an environment;
power connector means for connecting the apparatus to a power line;
signal connector means for connecting the sensor to a signal line and for outputting a signal on the signal line indicating whether the condition of the environment was detected;
network interface means for transmitting video captured by the video camera means to a remote location via a network;
memory means for storing access rights; and
controller means for receiving a signal from the sensor means indicating whether the condition of the environment was detected and for controlling access to video captured by the video camera means based on one or more of access rights of a user stored in the memory means and whether the condition of the environment was detected.

14. The apparatus of claim 13, wherein the video camera means is triggered to capture video in response to an alarm condition.

15. The apparatus of claim 14, wherein the alarm condition is triggered in response to the sensor means detecting the condition of the environment.

16. The apparatus of claim 15, further comprising video recognition module means for determining whether a captured image includes features of a predetermined individual.

17. A method comprising:
identifying an existing sensor in a security system, wherein the existing sensor includes a wired power connection and a wired signal line connection;
replacing the sensor with a sensor unit, the sensor unit including a network video camera and a sensor operable to detect a condition of an environment; and
connecting the sensor unit to the power connection such that the video camera and the sensor in the sensor unit receive power via the power connection; and
connecting the sensor to a signal line via the signal line connection, such that the sensor is operable to transmit a signal on the signal line indicating that an environmental condition was detected.

18. The method of claim 17, further comprising:
storing access rights in a memory for the sensor unit, the access rights being used to control remote access to video captured by the network video camera.

19. The method of claim 18, wherein the access rights include conditions indicating whether users are only allowed to receive the video in an alarm condition

20. The method of claim 17, further comprising:
triggering the network video camera to capture video in response to an alarm condition, wherein the alarm condition is triggered in response to the sensor in the sensor unit detecting the condition of the environment.
